(19) United States
(12) Patent Application Publication
(10) Pub. No.: US 2018/0275833 A1
(43) Pub. Date: Sep. 27, 2018

(54) SYSTEM AND METHOD FOR MANAGING AND DISPLAYING GRAPHICAL ELEMENTS

(71) Applicant: MZ IP Holdings, LLC, Palo Alto, CA (US)

(72) Inventors: Matt Walsh, San Carlos, CA (US); Matt Bradberry, Cupertino, CA (US)

(21) Appl. No.: 15/894,178

(22) Filed: Feb. 12, 2018

Related U.S. Application Data
(60) Provisional application No. 62/474,852, filed on Mar. 22, 2017.

(51) Int. Cl. G06F 3/0481; G06F 3/0484; G06T 11/60

(52) U.S. Cl. CPC G06F 3/0481; G06T 11/60; G06F 3/04842

(57) ABSTRACT

Implementations of the present disclosure are directed to a method, a system, and an article for managing and displaying graphical elements on a client device. An example computer-implemented method can include: presenting a first graphical element on a display of a client device; presenting a second graphical element that partially obstructs the first graphical element on the display, the second graphical element including an image; and determining that a third graphical element will be presented on the display and will partially occupy a location of the second graphical element, and, in response: rendering the image to an offscreen buffer; presenting the rendered image at the location of the second graphical element; and presenting the third graphical element to partially obstruct the rendered image.

### CROSS-REFERENCE TO RELATED APPLICATIONS

This application claims the benefit of U.S. Provisional Patent Application No. 62/474,852, filed Mar. 22, 2017, the entire contents of which are incorporated by reference herein.

### BACKGROUND

The present disclosure relates to presenting graphical elements on a display and, in certain examples, to systems and methods for managing the presentation on a client device of graphical elements created by a software application and an operating system.

In general, a software application and an operating system can create and present a wide variety of graphical elements on a display of a client device. The software application can present, for example, a graphical user interface, images, videos, and various combinations thereof. The operating system can present, for example, dialog windows, popup windows, or modal windows. In a typical situation, graphical elements created and presented by the operating system can be either fully unobstructed (e.g., displayed on top of other graphical elements) or fully obstructed (e.g., displayed beneath other graphical elements).

### SUMMARY

In general, the subject matter of this disclosure relates to systems and methods for managing and displaying a stack of graphical elements drawn by a software application and an operating system (OS). The approach can involve rendering an OS-generated graphical element to an offscreen buffer (e.g., to form an image of the OS-generated graphical element) and then presenting the offscreen buffer (e.g., the image) on a display as part of a stack of one or more other graphical elements. In this way, a copy of the OS-generated graphical element can be presented on the display and be partially obstructed by, for example, graphical elements drawn by the software application. Advantageously, the approach preserves the ability to render OS-generated graphical elements yet allows such graphical elements to be displayed, manipulated, and/or partially obstructed in a stack, along with other graphical elements.

In one aspect, the subject matter described in this specification relates to a computer-implemented method. The method includes: presenting a first graphical element on a display of a client device; presenting a second graphical element that partially obstructs the first graphical element on the display, the second graphical element including an image; and determining that a third graphical element will be presented on the display and will partially occupy a location of the second graphical element, and, in response: rendering the image to an offscreen buffer; presenting the rendered image at the location of the second graphical element; and presenting the third graphical element to partially obstruct the rendered image.

In certain examples, the first graphical element and the third graphical element can be presented by an application running on the client device, and the second graphical element can be presented by an operating system on the client device. The second graphical element can include an operating system dialog. The second graphical element can include a dialog box, a popup window, a modal window, and/or an overlay window. The second graphical element can be configured for (i) overlaying all other graphical elements at the location and/or (ii) being fully obstructed by other presented graphical elements.

In some implementations, rendering the image can include terminating the presentation of the second graphical element. The image can be or include text, a picture, a drawing, a frame of a video, a frame of an animation, and/or any combination thereof. In various instances, (i) the image can include a frame of a video, (ii) rendering the image can include rendering a plurality of frames from the video to the offscreen buffer, and (iii) presenting the rendered image can include presenting the rendered plurality of frames from the video. The method can include: detecting that a user of the client device has selected a region of the rendered image on the display; and mapping the selected region to a corresponding region in the second graphical element. The method can include: determining that the corresponding region in the second graphical element is a selectable region; and taking an action on the client device that is consistent with the selectable region.

In another aspect, the subject matter described in this specification relates to a system having one or more computer processors programmed to perform operations including: presenting a first graphical element on a display of a client device; presenting a second graphical element that partially obstructs the first graphical element on the display, the second graphical element including an image; and determining that a third graphical element will be presented on the display and will partially occupy a location of the second graphical element, and, in response: rendering the image to an offscreen buffer; presenting the rendered image at the location of the second graphical element; and presenting the third graphical element to partially obstruct the rendered image.

In certain instances, the first graphical element and the third graphical element can be presented by an application running on the client device, and the second graphical element can be presented by an operating system on the client device. The second graphical element can include an operating system dialog. The second graphical element can include a dialog box, a popup window, a modal window, and/or an overlay window. The second graphical element can be configured for (i) overlaying all other graphical elements at the location and/or (ii) being fully obstructed by other presented graphical elements.

In some examples, rendering the image can include terminating the presentation of the second graphical element. The image can be or include text, a picture, a drawing, a frame of a video, a frame of an animation, and/or any combination thereof. In various instances, (i) the image can include a frame of a video, (ii) rendering the image can include rendering a plurality of frames from the video to the offscreen buffer, and (iii) presenting the rendered image can include presenting the rendered plurality of frames from the video. The operations can include: detecting that a user of the client device has selected a region of the rendered image on the display; and mapping the selected region to a corresponding region in the second graphical element. The operations can include: determining that the corresponding region in the second graphical element is a selectable region; and taking an action on the client device that is consistent with the selectable region.

In another aspect, the subject matter described in this specification relates to an article. The article includes a non-transitory computer-readable medium having instructions stored thereon that, when executed by one or more computer processors, cause the computer processors to perform operations including: presenting a first graphical element on a display of a client device; presenting a second graphical element that partially obstructs the first graphical element on the display, the second graphical element including an image; and determining that a third graphical element will be presented on the display and will partially occupy a location of the second graphical element, and, in response: rendering the image to an offscreen buffer; presenting the rendered image at the location of the second graphical element; and presenting the third graphical element to partially obstruct the rendered image.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of a client device displaying graphical elements, in accordance with certain implementations of this disclosure.

FIG. 2 is a schematic diagram of an example system for managing and displaying graphical elements on client devices.

FIG. 3 is a schematic diagram of a client device displaying an OS-generated graphical element on top of a graphical element generated by a software application, in accordance with certain implementations of this disclosure.

FIG. 4 is a schematic diagram of a client device displaying an OS-generated graphical element that is partially obstructed and between two graphical elements generated by a software application, in accordance with certain implementations of this disclosure.

FIG. 5 is a flowchart of an example method of managing and displaying graphical elements on client devices.

### DETAILED DESCRIPTION

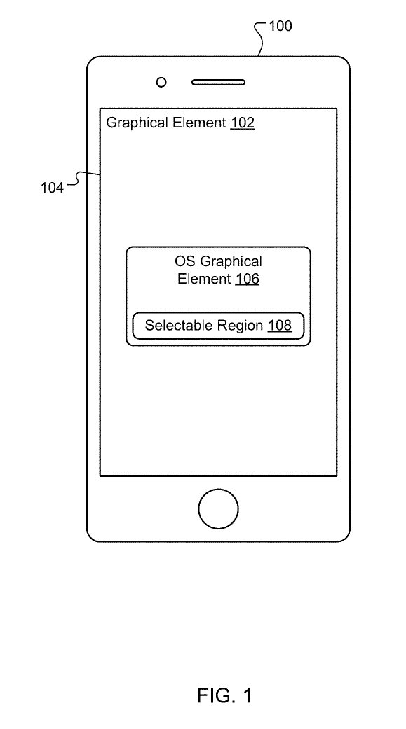

For computer software applications that run on operating systems (OSs) (e.g., mobile OSs), Graphical User Interface (GUI) contexts can co-exist with GUI elements of other applications and GUI elements of the OS itself. For example, referring to FIG. 1, a software application running on a client device 100 can present a graphical element 102 on a display 104 of the client device 100. The graphical element 102 can be or include, for example, text, an image, a video, or any combination thereof. When an OS on the client device 100 detects an event that requires attention from a user of the client device 100, the OS can render or draw an OS graphical element 106 (also referred to as a “native graphical element,” an “OS dialog,” or an “OS-generated graphical element”) on top of the graphical element 102. The OS graphical element 106 can inform the user about the event and can include one or more buttons or other selectable regions 108. The user can interact with the OS graphical element 106 by selecting the selectable region 108. For example, the user can close the OS graphical element 106 by selecting the selectable region 108, which can include a message such as “Close,” “Dismiss,” or similar text. In general, the OS can draw the OS graphical element 106 fully and/or unconditionally on top of the graphical element 102.

In certain instances, the OS graphical element 106 can be drawn by the OS without any instruction or request from the software application running on the client device (e.g., when a low battery is detected for the client device 100). There can be other instances, however, when it can be desirable for the software application to instruct the OS to draw the OS graphical element 106. For example, compared to the software application, the OS can be better suited or have a superior ability to render graphical elements related to, for example, HTML, blogs, web pages, and similar content. In such instances, the software application can take advantage of the OS's ability to create and display OS graphical elements.

Still referring to FIG. 1, when the desired placement of the OS graphical element 106 is fully on top of the graphical element 102, the two graphical elements can generally coexist and be displayed as desired. On the other hand, the OS graphical element 106 and/or the OS itself generally cannot tolerate a partial obstruction of the OS graphical element 106 by one or more other graphical elements. Instead, the OS graphical element 106 can be configured to be presented either (i) fully unobstructed or (ii) fully obstructed by other graphical elements. Partial obstruction of the OS graphical element 106 is generally not allowed. Advantageously, in various implementations, the systems and methods described herein are able to circumvent this issue, so that graphical elements drawn by the software application can partially obstruct the presentation of an OS graphical element, such as a dialog box, a popup, an overlay, or a modal window.

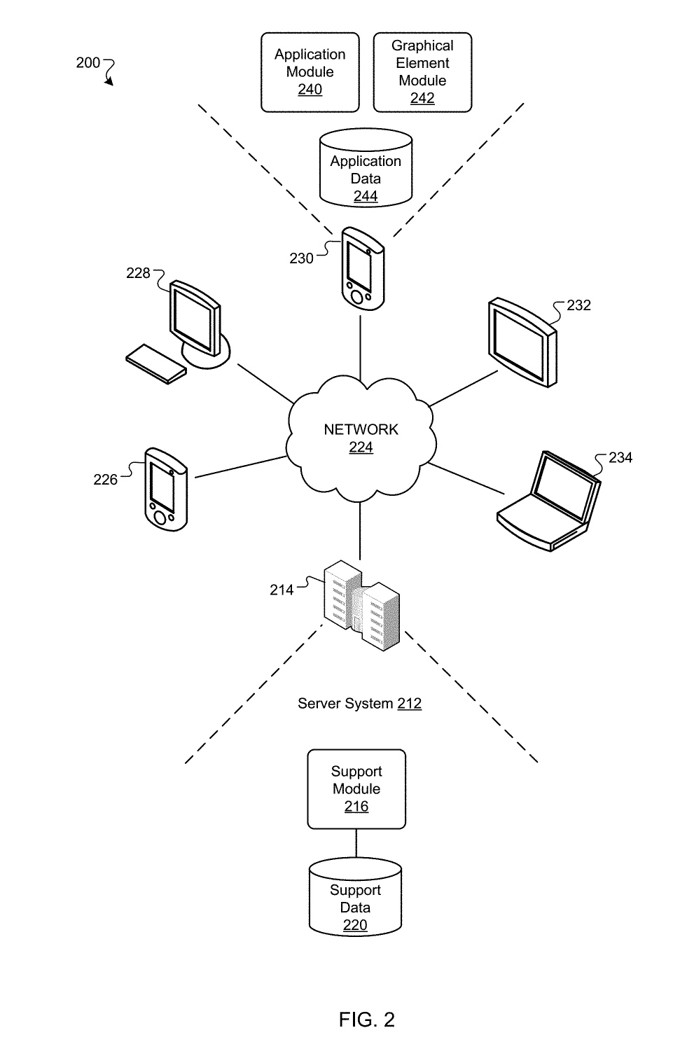

FIG. 2 illustrates an example system 200 for presenting graphical elements that can partially obstruct OS graphical elements drawn by an OS. A server system 212 provides functionality for a software application provided to a plurality of users. The server system 212 includes software components and databases that can be deployed at one or more data centers 214 in one or more geographic locations, for example. The server system 212 software components can include a support module 216 and/or can include subcomponents that can execute on the same or on different individual data processing apparatus. The server system 212 databases can include a support data 220 database. The databases can reside in one or more physical storage systems. The software components and data will be further described below.

An application, such as, for example, a web-based or other software application can be provided as an end-user application to allow users to interact with the server system 212. The software application can be accessed through a network 224 (e.g., the Internet) by users of client devices, such as a smart phone 226, a personal computer 228, a smart phone 230, a tablet computer 232, and a laptop computer 234. Other client devices are possible.

Each client device in the system 200 can utilize or include software components and databases for the software application. The software components on the client devices can include an application module 240 and a graphical element module 242. The application module 240 can implement the software application on each client device. The graphical element module 242 can be used to manage the presentation of graphical elements drawn by the software application and the OS (e.g., OS graphical elements) on each client device. The databases on the client devices can include an application data 244 database, which can store data for the software application and exchange the data with the application module 240 and/or the graphical element module 242. The data stored on the application data 244 database can include, for example, user data, image data, video data, and any other data used or generated by the application module 240 and/or the graphical element module 242. While the application module 240, the graphical element module 242, and the application data 244 database are depicted as being associated with the smart phone 230, it is understood that other client devices (e.g., the smart phone 226, the personal computer 228, the tablet computer 232, and/or the laptop computer 234) can include the application module 240, the graphical element module 242, the application data 244 database, and any portions thereof.

Still referring to FIG. 2, the support module 216 can include software components that support the software application by, for example, performing calculations, implementing software updates, exchanging information or data with the application module 240 and/or the graphical element module 242, and/or monitoring an overall status of the software application. The support data 220 database can store and provide data for the software application. The data can include, for example, user data, image data, video data, and/or any other data that can be used by the server system 212 and/or client devices to run the software application. In certain instances, for example, the support module 216 can retrieve image data or user data from the support data 220 database and send the image data or the user data to client devices, using the network 224.

The software application implemented on the client devices 226, 228, 230, 232, and 234 can relate to and/or provide a wide variety of functions and information, including, for example, entertainment (e.g., a game, music, videos, etc.), business (e.g., word processing, accounting, spreadsheets, etc.), news, weather, finance, sports, etc. In certain examples, the software application provides a multi-player online game.

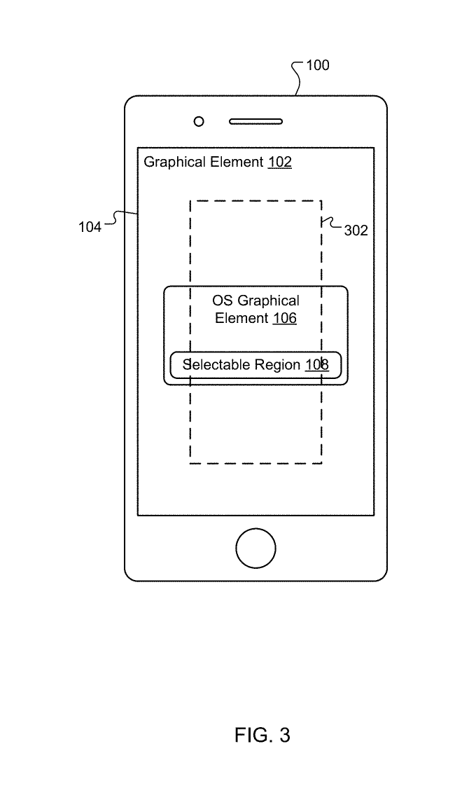

Referring to FIG. 3, in various instances, the OS on the client device 100 can draw the OS graphical element 106 over the graphical element 102, such that the graphical element 102 is at least partially obstructed by the OS graphical element 106. The OS in this case may have drawn the OS graphical element 106 based on instructions from the software application. For example, the software application may have instructed the OS to draw the OS graphical element 106 to present certain information related to the software application. Such information can include, for example, information related to current or future activity or events for the software application, such as promotions, sales, user chat messages, user blogs, and user activities. Other types of information can be presented in the OS graphical element 106. The OS graphical element 106 can include text, an image, a video, and any combination thereof and can be different in appearance (e.g., color and/or font style) from conventional or traditional OS graphical elements (e.g., used to inform a user about a low battery). The OS graphical element 106 can be generated from HTML, for example, by an OS HTML rendering context. In certain examples, the OS graphical element 106 can be or include an image, and the image can be or include text, a picture, a drawing, a frame of a video, a frame of an animation, and/or any combination thereof.

In some instances, the software application can attempt to draw an additional graphical element at a location 302, such that the OS graphical element 106 and the graphical element 102 would be at least partially obstructed by the additional graphical element. As described herein, however, the OS graphical element 106 typically cannot tolerate partial obstruction by other graphical elements.

To avoid this issue, certain implementations of the systems and methods described herein can achieve a partial obstruction of an OS graphical element by (i) rendering or copying the OS graphical element to an offscreen buffer (e.g., an image buffer) and (ii) drawing the offscreen buffer as a separate graphical element (referred to herein as a “buffer graphical element”) in a stack of graphical elements. The stack can include the buffer graphical element and one or more other graphical elements (e.g., drawn by the software application) and can be arranged in an order from lowest (e.g., drawn on a bottom of the stack) to highest (e.g., drawn on a top of the stack).

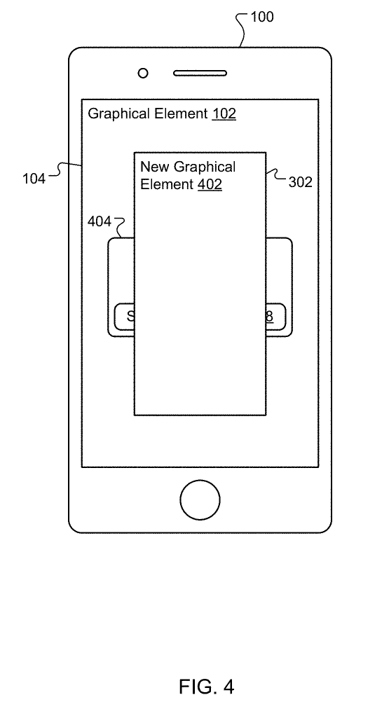

For example, referring to FIG. 4, a new graphical element 402 can be presented at the location 302 and on top of a buffer graphical element 404 and the graphical element 102, such that the buffer graphical element 404 is partially obstructed by the new graphical element 402. To draw the buffer graphical element 404, the OS graphical element 106 (from FIG. 3) can be rendered (e.g., as a bitmap or other image) to an offscreen buffer (e.g., in the application data 244 database) and the buffer can be presented on the display 104. The buffer graphical element 404 is preferably identical in appearance to the OS graphical element 106; however, unlike the OS graphical element 106, the buffer graphical element 404 can behave like other graphical elements drawn by the software application. This can allow the buffer graphical element 404 to be presented under one or more other graphical elements, without being fully obstructed. When the OS graphical element 106 is rendered to the offscreen buffer and/or the buffer graphical element 404 is presented on the display 104, there is generally no need to include the OS graphical element 106 in the stack.

In some implementations, the OS graphical element 106 can be or include an animation or a video and/or can otherwise change over time. To accommodate such changes, the OS graphical element 106 can be buffered periodically to the offscreen buffer so that new or updated versions of the buffer graphical element 404 can be created that reflect any changes occurring in the OS graphical element 106. For example, each time the software application and/or the OS will draw a new frame of the OS graphical element 106, the new frame can be rendered or copied to the offscreen buffer, and the updated buffer graphical element 404 can be displayed. To reduce a load on graphics hardware and/or software, the software application can sample the OS graphical element 106 and/or draw the buffer graphical element 404 at a desired sampling rate (e.g., 60 frames per second, 30 frames per second, 15 frames per second, 5 frames per second, or 1 frame per second). Alternatively or additionally, the software application can sample the OS graphical element 106 and/or draw the buffer graphical element 404 each time the OS graphical element 106 changes. This approach can be preferable when the load on the graphics hardware and/or software is low or not a significant concern.

A user of the client device 100 is preferably unable to distinguish any visible differences between the buffer graphical element 404 and the corresponding OS graphical element 106. For example, an image quality, resolution, color, size, frame rate, and other display characteristics for the buffer graphical element 404 and the OS graphical element 106 can be identical.

Additionally or alternatively, the buffer graphical element 404 is preferably able to be selected or otherwise manipulated by the user in a manner that is consistent with how the OS graphical element 106 can be selected and manipulated. For example, while the buffer graphical element 404 is being displayed on the client device 100, the client device 100 can detect user taps, clicks, swipes, and other types of user interactions with the display 104. When a location of a user interaction with the display 104 is determined to correspond with a selectable region of the buffer graphical element 404, the client device 100 can take an action consistent with the selectable region. For example, if the buffer graphical element 404 includes a button labeled “Close,” the client device 100 can close the buffer graphical element 404 when the user selects a location corresponding to the selectable region. Additionally or alternatively, the buffer graphical element 404 can present one or more links from the OS graphical element 106. When the user selects a location corresponding to one of the links, the client device can present the linked content (e.g., a webpage or a document). To achieve this functionality, the client device 100 and/or the software application can map the location of the user selection on the display 104 to a corresponding location in the OS graphical element 106. When the mapped location corresponds to a selectable region in the OS graphical element 106, the appropriate action for the selectable region can be taken by the client device 100. Additionally or alternatively, when a user attempts to select and move the buffer graphical element 404, the buffer graphical element can be moved to a new or different location on the display 104. Such movement can be accomplished without having to re-render the OS graphical element 106 to the offscreen buffer and/or create a new buffer graphical element 404.

In various implementations, the systems and methods described herein can utilize offscreen render-to-texture (RTT), which can involve instructing the OS to draw OS graphical elements in a place that is not visible to the end user, while optionally deferring event processing associated with the OS graphical element. Use of offscreen RTT can be desirable on mobile platforms where RTT processes can be difficult to fulfill unless the OS graphical element remains part of a render chain. On ANDROID devices, offscreen RTT can be achieved by hiding a visibility property of OS graphical elements, and invoking draw updates into an ANDROID drawing cache. This drawing cache can then be used to generate the necessary texture or buffer graphical elements to be displayed, as desired. On an APPLE mobile operating system (e.g., iOS), there may be no analogous drawing cache; however, iOS offscreen RTT can be achieved by expanding a view hierarchy into a simple tree, in which an abstract parent node can hold, for example, two child views. One of these child views can be an actual application view, in which all visual elements can be displayed. The other child view can be a “native elements view” where OS graphical elements can be drawn. When RTT is not used, the native elements view can be displayed as an overlay on other graphical elements (e.g., drawn by a software application). Alternatively or additionally, when RTT is used, the native elements view can be moved behind a sibling application view, where the native elements view can be drawn into a bitmap context without any interference or visibility relative to the user. Such hierarchical abstraction can allow the OS graphical elements to remain in a render chain, while not being visible to or selectable by the end user.

In some instances, to reduce loading on graphics hardware and/or software caused by the use of offscreen RTT, the systems and methods described herein can use an efficiency strategy (referred herein to as “Smart RTT”) that performs offscreen RTT only when needed. The Smart RTT algorithm can, for example, perform offscreen RTT only when an OS graphical element will be partially occluded or obstructed by one or more other graphical elements (e.g., drawn by the software application). In various examples, the Smart RTT algorithm can determine if an OS graphical element is below any other graphical elements in the stack and, if so, run an intersection test against a bounding rectangle for each graphical element to detect the presence of visibility occlusion. If an occlusion check determines that there are one or more graphical elements (e.g., application level) that occlude the OS graphical element, then an offscreen RTT request can be submitted and subsequently sampled. Otherwise, if no occlusion is detected, there may be no need for the offscreen RTT, and the OS graphical element can be presented on the display, for example, with no need to render the OS graphical element to an offscreen buffer or create a corresponding buffer graphical element.

In alternative examples, the systems and methods can be configured to always render OS graphical elements to the offscreen buffer and present corresponding buffer graphical elements. The software application can then capture and map any user input (e.g., swipes, taps, clicks, etc.) to the OS graphical element to determine what action, if any, should be taken based on the user input. Alternatively or additionally, use of the offscreen buffer and buffer graphical elements can be limited to situations where an OS graphical element is partially blocked by one or more other graphical elements. In such an instance, when the partial obstruction is removed (e.g., by closing and/or moving one or more graphical elements), the systems and methods can stop rendering the OS graphical element to the offscreen buffer and begin rendering the OS graphical element directly to the display. If a partial obstruction occurs again later (e.g., due to creation or movement of one or more graphical elements), the systems and methods can again render the OS graphical element to the offscreen buffer to create and display the buffer graphical element.

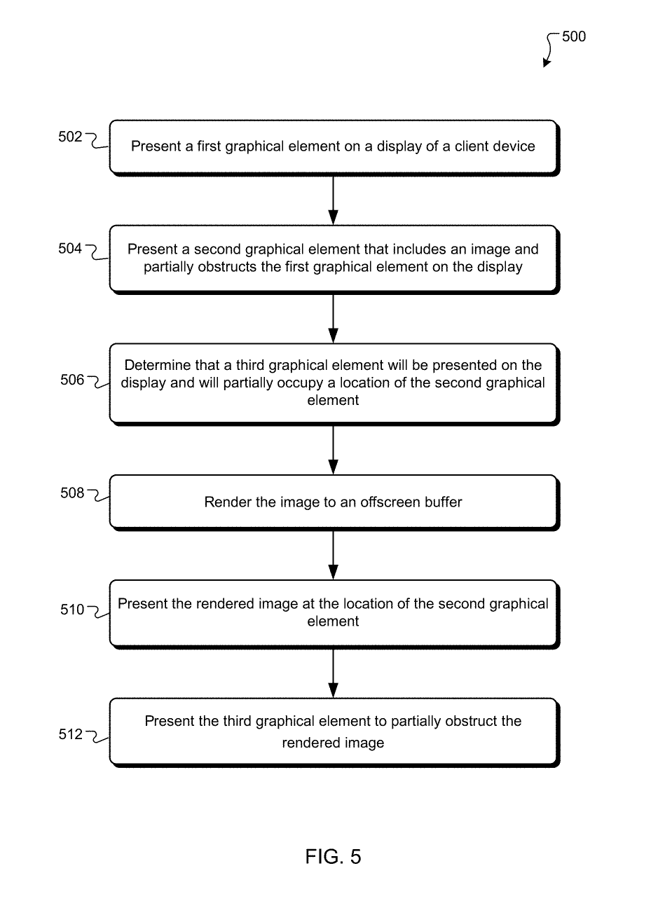

FIG. 5 illustrates an example computer-implemented method 500 of managing and displaying graphical elements on a client device. A first graphical element is presented (step 502) on a display of a client device. A second graphical element that includes an image (e.g., text, a picture, a drawing, a frame of a video, a frame of an animation, and/or any combination thereof) and partially obstructs the first graphical element is presented (step 504) on the display. Next, it is determined (step 506) that a third graphical element will be presented on the display and will partially occupy a location of the second graphical element. In response to the determination, the image is rendered (step 508) to an offscreen buffer, the rendered image is presented (step 510) at the location of the second graphical element, and the third graphical element is presented (step 512) to partially obstruct the rendered image.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method, comprising:
presenting a first graphical element on a display of a client device;
presenting a second graphical element that partially obstructs the first graphical element on the display, the second graphical element comprising an image; and
determining that a third graphical element will be presented on the display and will partially occupy a location of the second graphical element, and, in response:
rendering the image to an offscreen buffer;
presenting the rendered image at the location of the second graphical element; and
presenting the third graphical element to partially obstruct the rendered image.

2. The method of claim 1, wherein the first graphical element and the third graphical element are presented by an application running on the client device, and wherein the second graphical element is presented by an operating system on the client device.

3. The method of claim 1, wherein the second graphical element comprises an operating system dialog.

4. The method of claim 1, wherein the second graphical element comprises at least one of a dialog box, a popup window, a modal window, and an overlay window.

5. The method of claim 1, wherein the second graphical element is configured for one of (i) overlaying all other graphical elements at the location and (ii) being fully obstructed by other presented graphical elements.

6. The method of claim 1, wherein rendering the image comprises:
terminating the presentation of the second graphical element.

7. The method of claim 1, wherein the image comprises at least one of text, a picture, a drawing, a frame of a video, a frame of an animation, and any combination thereof.

8. The method of claim 7, wherein (i) the image comprises a frame of a video, (ii) rendering the image comprises rendering a plurality of frames from the video to the offscreen buffer, and (iii) presenting the rendered image comprises presenting the rendered plurality of frames from the video.

9. The method of claim 1, further comprising:
detecting that a user of the client device has selected a region of the rendered image on the display; and
mapping the selected region to a corresponding region in the second graphical element.

10. The method of claim 9, further comprising:
determining that the corresponding region in the second graphical element is a selectable region; and
taking an action on the client device that is consistent with the selectable region.

11. A system, comprising:
one or more computer processors programmed to perform operations comprising:
presenting a first graphical element on a display of a client device;
presenting a second graphical element that partially obstructs the first graphical element on the display, the second graphical element comprising an image; and
determining that a third graphical element will be presented on the display and will partially occupy a location of the second graphical element, and, in response:
rendering the image to an offscreen buffer;
presenting the rendered image at the location of the second graphical element; and
presenting the third graphical element to partially obstruct the rendered image.

12. The system of claim 11, wherein the first graphical element and the third graphical element are presented by an application running on the client device, and wherein the second graphical element is presented by an operating system on the client device.

13. The system of claim 11, wherein the second graphical element comprises an operating system dialog.

14. The system of claim 11, wherein the second graphical element is configured for one of (i) overlaying all other graphical elements at the location and (ii) being fully obstructed by other presented graphical elements.

15. The system of claim 11, wherein rendering the image comprises:
terminating the presentation of the second graphical element.

16. The system of claim 11, wherein the image comprises at least one of text, a picture, a drawing, a frame of a video, a frame of an animation, and any combination thereof.

17. The system of claim 16, wherein (i) the image comprises a frame of a video, (ii) rendering the image comprises rendering a plurality of frames from the video to the offscreen buffer, and (iii) presenting the rendered image comprises presenting the rendered plurality of frames from the video.

18. The system of claim 11, further comprising:
detecting that a user of the client device has selected a region of the rendered image on the display; and
mapping the selected region to a corresponding region in the second graphical element.

19. The system of claim 18, further comprising:
determining that the corresponding region in the second graphical element is a selectable region; and
taking an action on the client device that is consistent with the selectable region.

20. An article, comprising:
a non-transitory computer-readable medium having instructions stored thereon that, when executed by one or more computer processors, cause the computer processors to perform operations comprising:
presenting a first graphical element on a display of a client device;
presenting a second graphical element that partially obstructs the first graphical element on the display, the second graphical element comprising an image; and
determining that a third graphical element will be presented on the display and will partially occupy a location of the second graphical element, and, in response:
rendering the image to an offscreen buffer;
presenting the rendered image at the location of the second graphical element; and
presenting the third graphical element to partially obstruct the rendered image.
